(19) United States
(12) Patent Application Publication
(10) Pub. No.: US 2025/0348715 A1
(43) Pub. Date: Nov. 13, 2025

(54) RESPONSE-ADAPTIVE CALIBRATION FOR POST-TRAINING QUANTIZATION OF LARGE LANGUAGE MODELS

(71) Applicants: Ali EDALATI, Montreal (CA); Seyed Alireza GHAFFARI, Brossard (CA); Masoud ASGHARIAN--DASTENAEI, Montreal (CA); Lu HOU, Shenzhen (CN); Boxing CHEN, Ottawa (CA); Vahid PARTOVI NIA, Brossard (CA)

(72) Inventors: Ali EDALATI, Montreal (CA); Seyed Alireza GHAFFARI, Brossard (CA); Masoud ASGHARIAN--DASTENAEI, Montreal (CA); Lu HOU, Shenzhen (CN); Boxing CHEN, Ottawa (CA); Vahid PARTOVI NIA, Brossard (CA)

(21) Appl. No.: 19/074,268

(22) Filed: Mar. 7, 2025

Related U.S. Application Data
(60) Provisional application No. 63/643,679, filed on May 7, 2024.

(51) Int. Cl. G06N 3/0495; G06N 3/0455; G06N 3/082; G06N 3/084

(52) U.S. Cl. CPC G06N 3/0495; G06N 3/0455; G06N 3/082; G06N 3/084

(57) ABSTRACT

Post-training quantization of Large Language Models and other neural networks. A plurality of quantization iterations are applied during which each of the linear network layers of a block are processed as follows: a respective approximated Hessian matrix is computed for the linear network layer using a set of layer-specific network weights for the linear network layer as computed in a preceding quantization iteration and sets of layer-specific network weights for each of the remaining linear network layers set to the values of such weights prior to the preceding quantization iteration; then an updated set of quantized set of layer-specific network weights for the linear network layer is computed based on the respective approximated Hessian matrix for the linear network layer. The updated quantized sets of layer-specific network weights computed in a final quantization iteration are stored as a final quantized set of parameters for the block.

### RELATED APPLICATION DATA

This application claims priority to and benefit of U.S. Provisional Patent Application No. 63/643,679 filed May 7, 2024, the contents of which are incorporated herein by reference.

### FIELD

The present application generally relates to systems, models, and computer programs for implementing large language models and in particular to Response-Adaptive Calibration for Post-training Quantization of Large Language Models.

### BACKGROUND

Recently, Large Language Models (LLMs) have been developed as transformer-based neural networks (NNs), achieving state-of-the-art performance on many natural language processing (NLP) tasks such as question answering, machine translation, and text summarization.

The size of LLMs has been rapidly increasing to achieve a more accurate performance. However, the growing size of LLMs is a barrier to their deployment, specifically on resource-limited devices. As the size of these models increases, their latency increases while powerful devices with larger memories are required to deploy them with more electrical power consumption.

Post-training Quantization (PTQ) methods have been introduced to overcome these challenges by reducing the number of bits per parameter required for the deployment of LLMs. PTQ methods investigate and introduce different approaches to reduce the quantization error without further training. These methods often perform a calibration process to match the accuracy of the quantized and original model. The calibration process tries to match the output of each individual layer in the quantized and original model separately. Here, we briefly discuss the most recent PTQ techniques developed for LLMs.

There are plenty of PTQ techniques and approaches available for neural networks [See References 1,2,3,4,5,6,7 (document citations provided below)]. However, extremely low-bit (2 or 3 bits) PTQ of LLMs is still an open challenge since the proposed techniques suffer from a significant performance degradation, casting a shadow of doubt on commercial use of extremely-low bit quantized models.

Various proposed PTQ techniques and their respective shortcomings are as follows.

(1) OPTQ: Accurate Post-Training Quantization for Generative Pre-trained Transformers [REFERENCE 4]—OPTQ is one of the first methods that successfully performed calibration on top of PTQ for LLMs. OPTQ (formerly known as GPTQ) computes the Hessian matrix for each linear layer of the LLM separately with respect to the loss function which is mean squared error (MSE) between the output of the quantized and original layers. Therefore, the Hessian matrix for each linear layer is computed to correct the output of the linear layer, individually. Then, the weight matrix of the layer is column-by-column quantized while the remaining columns are updated based on an update formula derived from [REFERENCE 8] to reduce the quantization error on the output of the layer. The invert of the Hessian matrix is an important term used in the update formula. OPTQ enabled 4-bit quantization of LLMs with an acceptable accuracy drop compared to the original model.

A disadvantage of OPTQ is that it does not handle outliers. In addition, OPTQ's goal is to correct the output of each linear layer separately, ignoring the final output of the model. Therefore, OPTQ is response-agnostic, resulting in sub-optimal accuracy.

(2) QuIP: 2-Bit Quantization of Large Language Models with Guarantees [REFERENCE 5]—QuIP introduced a PTQ method which uses a generalized version of the update formula used in OPTQ [REFERENCE 4] to perform the calibration on top of the quantized model. Similar to OPTQ, this solution aims to match the output of the linear layers between the quantized and original model separately. Therefore, QuIP uses the same strategy as OPTQ for Hessian computation, which is response-agnostic. Furthermore, QuIP performs incoherence processing on the weights and Hessians to improve the results. QuIP enabled 2-bit quantization of LLMs with a reasonable performance drop.

A disadvantages of QuIP is that it uses the same strategy as OPTQ for Hessian computation, which is response-agnostic, leading to sub-optimal accuracy.

(3) SqueezeLLM: Dense-and-Sparse Quantization [REFERENCE 6]—This method detects the most sensitive weights for quantization in the target model as outliers and isolates them as sparse floating-point parameters. Then, the non-sensitive weights are clustered into different groups by K-means clustering followed by non-uniform quantization. SqueezeLLM relies on Hessian matrices of linear layers to measure the sensitivity of weights to quantization in each layer. Therefore, the Hessian matrix of each linear layer is approximated by the Fisher information matrix, computed by averaging the multiplication of the transposed gradient and gradient matrices over the calibration set. SqueezeLLM does not perform any kind of calibration and uses the Hessians only for outlier detection.

A Disadvantage of SqueezeLLM is that non-uniform quantization yields extra computational challenges during inference leading to a demand for specialized CUDA kernels. Also, this method underperforms QuIP and Sparse-Quantized Representation (SpQR, see below) at 3-bit quantization based on our results. Also, this method is not applied for 2-bit quantization.

(4) SpQR: A Sparse-Quantized Representation for Near-Lossless LLM Weight Compression [REFERENCE 7]—SpQR uses the same update formula and Hessian computation strategy as OPTQ [REFERENCE 4] for calibration. However, before calibration, the outliers are detected and isolated from quantization. Further, the size of quantization groups is reduced while the generated scales and zeros are also quantized to reduce the final average bits. A disadvantage of SpQR is that it can achieve sub-optimal accuracy, particularly on 2-bit quantization.

Accordingly, there is a need for methods and systems that can address at least some of the shortcomings noted above

### SUMMARY

According to example aspects, a method is provided for response-adaptive calibration for post-training quantization of large language models.

According to a first example aspect, a computer implemented method for post-training quantization (PTQ) of a trained neural network is disclosed. The trained neural network includes a block of linear network layers, the block being configured by a non-quantized set of trained parameters that comprise, for each of the linear network layers within the block, respective layer-specific network weights. The method includes performing a plurality of quantization iterations to generate a final quantized set of parameters for the block corresponding to the non-quantized set of trained parameters, the quantized set of parameters having a reduced number of bits than the non-quantized set of trained parameters. Each quantization iteration includes successively processing each of the linear network layers, wherein the processing for each liner network layer includes: computing a respective approximated Hessian matrix for the linear network layer based on outputs generated by the block for a set of calibration samples using a set of interim quantized parameters for the block, the set of interim quantized parameters comprising a set of layer-specific network weights for the linear network layer as computed in a preceding quantization iteration and sets of layer-specific network weights for each of the remaining linear network layers set to the values of such weights prior to the preceding quantization iteration, and computing an updated set of quantized set of layer-specific network weights for the linear network layer based on the respective approximated Hessian matrix for the linear network layer. The updated quantized sets of layer-specific network weights computed for each of the linear network layers in a final quantization iteration of the plurality of quantization iterations are stored as the final quantized set of parameters for the block.

In some examples, computing the respective approximated Hessian matrix for the linear network layer includes: computing final outputs of the trained neural network for all of the calibration samples in the set of calibration samples; computing a loss for all the calibration samples based on a comparison of the final outputs to ground truth values of the calibration samples determined for the neural network using the non-quantized set of trained parameters; computing, based on the computed loss, a gradient matrix for the updated set of layer-specific network weights for the linear network layer; and computing the respective approximated Hessian matrix for the linear network layer based on the gradient matrix.

In one or more of the preceding examples, the computed loss is a cross-entropy loss, and computing the gradient matrix comprises applying backpropagation to compute the gradient matrix.

In one or more of the preceding examples, computing the respective approximated Hessian matrix for the linear network layer comprising computing a Fisher information matrix.

In one or more of the preceding examples, computing the updated set of quantized set of layer-specific network weights for the linear network layer includes: detecting, based on the approximated Hessian matrix for the linear network layer, outlier weights in the set of layer-specific network weights for the linear network layer as computed in the preceding quantization iteration; quantizing any non-outlier weights in the set of layer-specific network weights while maintaining any outlier weights at their respective non-quantized values; and outputting a matrix comprising the quantized non-outlier weights and the non-quantized outlier weights as the updated set of quantized set of layer-specific network weights.

In one or more of the preceding examples, the non-outlier weights are quantized on column-by-column basis.

In one or more of the preceding examples, computing the updated set of quantized set of layer-specific comprises applying unstructured pruning to the set of layer-specific network weights based on the approximated Hessian matrix for the linear network layer.

In one or more of the preceding examples, computing the respective approximated Hessian matrix for the linear network layer comprises computing an approximated gradient matrix for the linear network layer based on input values included in the calibration samples.

In one or more of the preceding examples the trained neural network comprises a large language model, and the block of linear network layers are part of a transformer block of a decoder network of the large language model.

In one or more of the preceding examples, the method includes deploying a low-bit deep neural network version of the trained neural network, the low-bit deep neural network comprising a block of linear network layers being configured by the final quantized set of parameters.

In some examples, the method includes performing a task using the low-bit deep neural network version, the task being selected from a group consisting of: machine translation; image captioning; information extraction; text summarization; question answering; and chatbot dialog generation.

According to a further example aspect, a system is disclosed that includes or more processors, and one or more memories storing machine-executable instructions thereon which, when executed by the one or more processors, cause the system to perform the method of any one of the preceding methods.

According to a further example aspect, a non-transitory processor-readable medium is disclosed having machine-executable instructions stored thereon which, when executed by one or more processors, cause the one or more processors to perform the method of any one of the preceding methods.

According to a further example aspect, computer program is disclosed that configures a computer system to perform the method of any one of the preceding methods.

According to a further example aspect, an apparatus is disclosed that is configured to perform the method of any one of the preceding methods.

### BRIEF DESCRIPTION OF THE DRAWINGS

Reference will now be made, by way of example, to the accompanying drawings which show example embodiments of the present application, and in which:

FIG. 1 is a is a schematic diagram showing an artificial intelligence (AI) engine, wherein the AI engine comprises a large language model (LLM).

FIG. 2A is a schematic diagram showing an encoder-based LLM.

FIG. 2B is a schematic diagram showing a decoder-based LLM.

FIG. 2C is a schematic diagram showing an encoder-decoder-based.

FIG. 3 is a block diagram showing an example of a response-agnostic computation of a Hessian matrix for a model layer when the loss function is the MSE between the output of the quantized and original layers.

FIG. 4 is a block diagram illustrating computation of a response-adaptive Hessian matrix when the objective is correcting the final output of the model, according to example implementations.

FIG. 5 is a block diagram illustrating a process for obtaining and deploying a compressed model according example implementations.

FIG. 6A is a block diagram illustrating a quantization process according to an example implementation.

FIG. 6B illustrates an example of a Hussain matrix approximation according to an example implementation.

FIG. 6C shows a pseudocode representation of the output-adaptive process of FIG. 6A using, for example, the Hessian approximation of FIG. 6B, according to an example implementation.

FIG. 7 is a block diagram illustrating a quantization process according to further example implementations.

FIG. 8 is a block diagram illustrating a quantization process according to further example implementations.

FIG. 9 is a block diagram illustrating a quantization process according to further example implementations.

FIG. 10 is a block diagram of a computer system that can be configured to implement aspects of the disclosed methods and systems.

Similar reference numerals may have been used in different figures to denote similar components.

### DESCRIPTION OF EXAMPLE EMBODIMENTS

Throughout this disclosure, the following terms can have the following meanings unless context requires otherwise.

Neural Network (“NN”): A model that performs decision making by processing an input through a network composed of layers of interconnected nodes.

Transformer: A particular type of NN that includes a mechanism to capture attention in the input [See, for example, REFERENCE 23].

LLMs: Models that are used to understand and generate language. Novel LLMs are all transformer-based NN, trained on massive amount of data.

Quantization: Quantization is referred to reducing the number of bits allocated to each parameter in favor of memory or time efficiency [See, for example, REFERENCE 24]. If the original parameters are uniformly projected into the quantized parameters, the method is classified as uniform quantization, otherwise, it is a type of non-uniform quantization. Usually, non-uniform quantization methods cause less error while bringing more efficiency challenges at deployment [See, for example, REFERENCE 24]. By way of example, 16 or 32 bits are often allocated to represent each parameter of a NN quantization can be used to reduce the number of bits from 16 or 32 to lower amounts, for example 2 bits.

Pruning: Removing unnecessary parameters of a neural network to achieve a compressed model with a similar accuracy is called pruning. Structured and unstructured pruning are the main existing types of pruning. Unstructured pruning means removing unnecessary individual parameters while structured pruning removes grouped unnecessary parameters that could be matrices, layers, channels, or blocks [See, for example, REFERENCE 25].

Taylor Expansion: An expansion used to approximate the change in output of a differentiable function, when its input is slightly tweaked. Since PTQ slightly changes the weights of a NN, Taylor expansion can be used to estimate the imposed error on output.

Calibration: The process of slightly modifying the quantized weights of a model to reduce the quantization error is called calibration.

Calibration set: A set of N data samples that are used to calibrate a quantized model. The size of calibration set is often relatively small.

Loss function: The difference between the generated output of a model and the ground truth output is measured by a function, called loss function. In this document, the loss function is denoted by [symbol] (·).

Gradient matrix: The first derivative of the loss function [symbol] with respect to parameters is called the gradient. Similar to most NNs, LLMs are composed of linear layers. Each linear layer has a weight matrix like Wϵ [symbol] . For each linear layer, the gradient matrix, Gϵ [symbol] , is defined as:

$$G = [ \begin{matrix}\frac{\partial ℒ}{\partial {w}_{1 , 1}} & ⋯ & \frac{\partial ℒ}{\partial {w}_{1 , n}} \\ ⋮ & ⋱ & ⋮ \\ \frac{\partial ℒ}{\partial {w}_{m , 1}} & ⋯ & \frac{\partial ℒ}{\partial {w}_{m , n}}\end{matrix} ]$$

For the i^{th} sample in the calibration set, the gradient matrix is denoted by Gᵢ.

Backpropagation: The process of computing the gradients for parameters of a NN after computing the loss function is called backpropagation.

Hessian matrix: The second derivative of a loss function with respect to parameters is called Hessian matrix (also referred to herein using the shortened form “Hessian”), and is denoted by H in this document. This Hessian matrix and its inverse are used for calibration of quantized models.

Transpose: An operator on a matrix, Wϵ [symbol] , that flips the order of elements.

$$transpose ( W ) = {W}^{T} = [ \begin{matrix}{w}_{1 , 1} & ⋯ & {w}_{m , 1} \\ ⋮ & ⋱ & ⋮ \\ {w}_{1 , n} & ⋯ & {w}_{m , n}\end{matrix} ] ∈$$

Round to Nearest (RTN): Quantizing the weights into the nearest integer without any further calibration or sophisticated technique to reduce the error.

Response-adaptive: refers to considering the final output of the model, for example, during calibration.

Response-agnostic: refers to ignoring the final output of the model, for example, during calibration.

Outliers: Parameters (e.g., weights) that are more sensitive to quantization, causing more error after quantization, are called outliers. Often, a relatively small set out of entire weights that are the most sensitive ones are classified as outliers [See, for example, REFERENCE 7].

CUDA (Compute Unified Device Architecture): A programming platform that enables general parallel computing on GPUs.

Perplexity: A metric for measuring the quality of the generated responses by a language model. Less perplexity means the model generates higher-quality outputs.

By way of context, a neural network is a computational system comprising computational units (sometimes referred to as neurons) that are arranged in layers (or computational blocks). A neural network includes a first neural network layer (which may be referred to as an input layer), at least one intermediate neural network layer (which may be referred to as intermediate layer(s)) and a final neural network layer (which may be referred to as an output layer). Each neural network layer receives input data (e.g., in the form of an input vector) and performs computations, including applying some weights (e.g., in the form of a weight vector) to the input data to generate output data (e.g., in the form of an output vector). If a neural network has multiple intermediate layers, the output generated by one intermediate layer (which may be referred to as intermediate data) may be used as the input data to a subsequent intermediate layer. The output of a multi-layer neural network is the output generated by the final layer.

When a neural network is executed (e.g., during training or inference), the output of each neural network layer is computed in sequence. Often, computing a neural network layer involves computing an inner product between the input data and the weights of the neural network layer. With increasing neural network complexity (e.g., increasing number of layers), there is an increase in computation cost and memory cost, which may limit the accessibility and/or commercial practicality of more complex neural network architectures.

Foundation models (FMs) or language models (LMs) such as Large Language Models (LLMs) are computational models used for language generation and other natural language processing, such as text classification. Some LLMs may obtain these abilities by learning the statistical relationship between language tokens through intensive training procedures. With the rapid growth of model size, transformer-based LLMs have shown results in domains such as, for example, instruction following, coding assistance, and creative writing. Among these tasks, unlocking the rationality of LLMs to solve complex reasoning tasks remains a major challenge. Recent works have attempted to tackle this challenge through Supervised Fine-Tuning (SFT). By mixing crafted new reasoning data samples with original datasets, LLMs learn the underlying distributions of these samples and attempt to mimic the logic they have learned to solve unseen reasoning tasks. Although there is a performance gain, this method heavily relies on extensive training and requires extra data preparation.

Large language models (LLMs) are neural network models that learn the semantics and syntax of language by encoding words or subwords into vector representations. These models are trained on extensive datasets and are widely used in various artificial intelligence (AI) applications, including text generation, sentiment analysis, and generic question-answering (QA) systems. LLMs enable these systems to understand and generate responses to a broad range of queries, making them integral to applications like virtual assistants and chatbots.

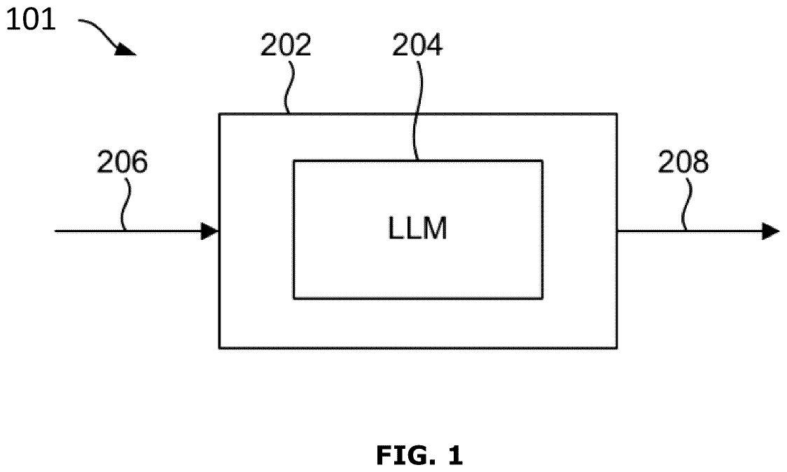

FIG. 1 is a schematic diagram showing an artificial intelligence (AI) engine, wherein the AI engine comprises a large language model (LLM)

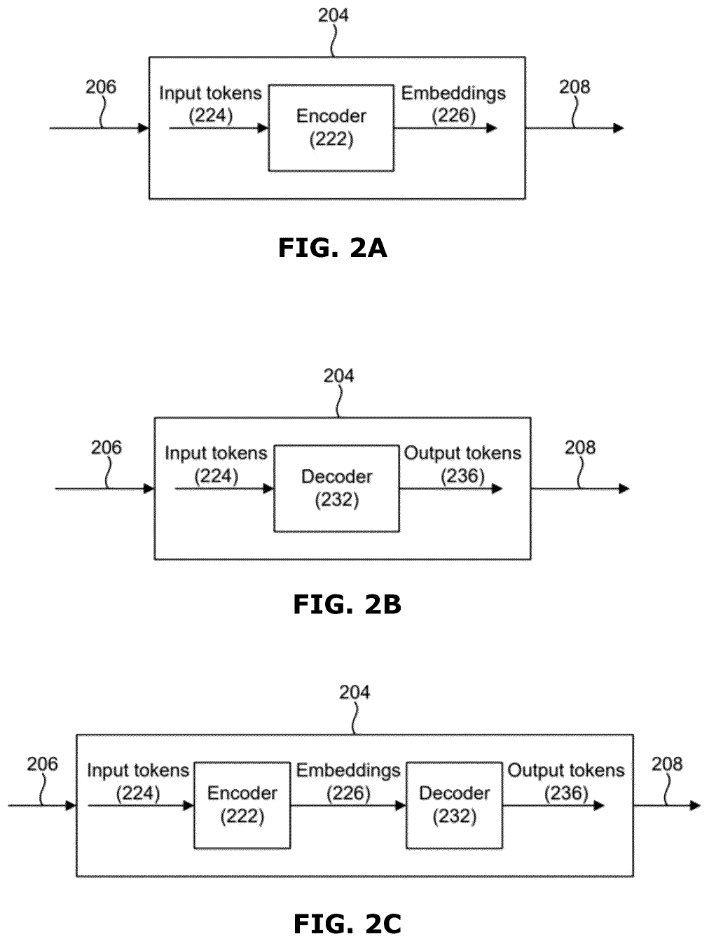

FIGS. 2A to 2C are schematic diagrams showing different types of the LLMs shown in FIG. 1, wherein: FIG. 2A is a schematic diagram showing an encoder-based LLM, FIG. 2B is a schematic diagram showing a decoder-based LLM, and FIG. 2C is a schematic diagram showing an encoder-decoder-based LLM.

In some embodiments, the computer network system 101 executes an artificial intelligence (AI) engine (for example, in the form of one or more software programs). As shown in FIG. 1, the AI engine 202 comprises a FM such as an LLM 204 (which is used as an example in the following description) for processing input 206 (also called “prompt”; for example, natural language input in the form of text, image, voice, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub)words into vector representations.

More specifically, a FM such as an LLM is a computational model that may rely on a large number of computing parameters to perform general purpose text generation and other language tasks such as text classification. LLMs may obtain these abilities by learning the statistical relationship between language tokens through intensive training procedures. A training procedure of an LLM is a procedure during which an LLM learns the statistical relationship between language tokens, usually through auto-regressive learning on some corpus, e.g., predicting the next token given the previous tokens. During this procedure, the ground truth of the tokens to be predicted is known and the errors between the prediction and the ground truth may be iteratively minimized via back-propagation.

Examples of LLMs include ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLaMA (a family of autoregressive large language models released by Meta AI of Astor Place, New York City, New York, USA), and PaLM2 (a transformer-based large language model developed by Google AI of Mountain View, California, USA), which have proven to achieve state-of-the-art (SOTA) performance in various natural language processing (NLP) tasks.

FIGS. 2A to 2C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 2A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 2B, the LLM 204 may be an LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 2C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

The present disclosure presents methods and systems related to post training quantization (PTQ) of NNs, including large language models (LLMs), and discloses PTQ calibration solutions that are response-adaptive rather than response-agnostic. In at least some examples, the disclosed methods and system can improve the operation and functioning of a computer system on which they are operating when compared to known PTQ solutions.

Previously known calibration techniques for LLMs are response-agnostic, ignoring the final output of the model while matching the output of each linear layer between the quantized and original model separately. This limits the ability of known calibration techniques to recover performance, leading to a significant accuracy gap between the original and calibrated-quantized models, especially at extremely low-bit quantization. Therefore, known calibration techniques fail to generate a reliable quantized model for real-world applications.

The presently disclosed calibration solution, on the other hand, aims to correct the final output of the quantized model during calibration to make the calibration response-adaptive, which can lead to more accurate compressed models when compared to prior art, especially at extreme low-bit quantization, that is suitable for real-world scenarios.

By way of illustrative example of how the presently disclosed calibration solutions can improve the performance of a computer system, Table 1 below shows the gained perplexity for model that has been calibrated in accordance with the presently disclosed solution for 2-bit quantization of OPT-7B on three datasets compared to representative known PTQ solutions.

TABLE 1
Achieved perplexity on C4, Wikitext2, and PTB datasets after applying
various PTQ methods on OPT-7B to perform 2-bit quantization.

| | method | | | | |
|---|---|---|---|---|---|
| | | | | | Presently |
| | no | | | | Disclosed |
| dataset | compression | OPTQ | QuIP | SpQR | Solution |
| C4 [REF 26] | 12.19 | 97.69 | 16.37 | 14.90 | 14.42 |
| Wikitext2 [REF | 10.86 | 451.30 | 16.23 | 14.18 | 13.60 |
| 27] | | | | | |
| PTB [REF 28] | 12.17 | 178.24 | 16.67 | 15.07 | 14.72 |

As noted above, previously known calibration techniques are response-agnostic. In this regard, during the calibration of each layer of the subject model, the Hessian matrix determines the direction in which the weights are updated to reduce the quantization error. If the quantization error is defined based on the MSE between the output of the quantized and original layer (as done in OPTQ [REFERENCE 4], QuIP [REFERENCE 5], and SpQR [REFERENCE 7]), the Hessian matrix is computed in a response-agnostic way, in which the final output of the model is ignored. Therefore, the response-agnostic Hessian matrix for the linear layers is computed as:

$${H}_{response - agnostic} = \frac{1}{N} {\sum }_{i = 1}^{N} {X}_{i}^{T} {X}_{i}$$

where:
N is the size of the calibration set; and
Xᵢ is an input matrix to a linear layer corresponding to the i^{th} calibration sample.

However, the present disclosure provides as solution wherein the Hessian matrix used for calibration is computed in a response-adaptive manner that directly reduces the difference between the final output of the quantized and original model. Since it is extremely difficult to find the exact Hessian matrix with respect to the final loss, in example implementations, the Hessian matrix is approximated for each layer by averaging the multiplication of the transposed gradient and gradient matrices over the calibration set:

$${H}_{response - adaptive} \approx \frac{1}{N} {\sum }_{i = 1}^{N} {G}_{i}^{T} {G}_{i}$$

where:
N is the size of the calibration set; and
Gᵢ is the gradient matrix corresponding to the i^{th} calibration sample.

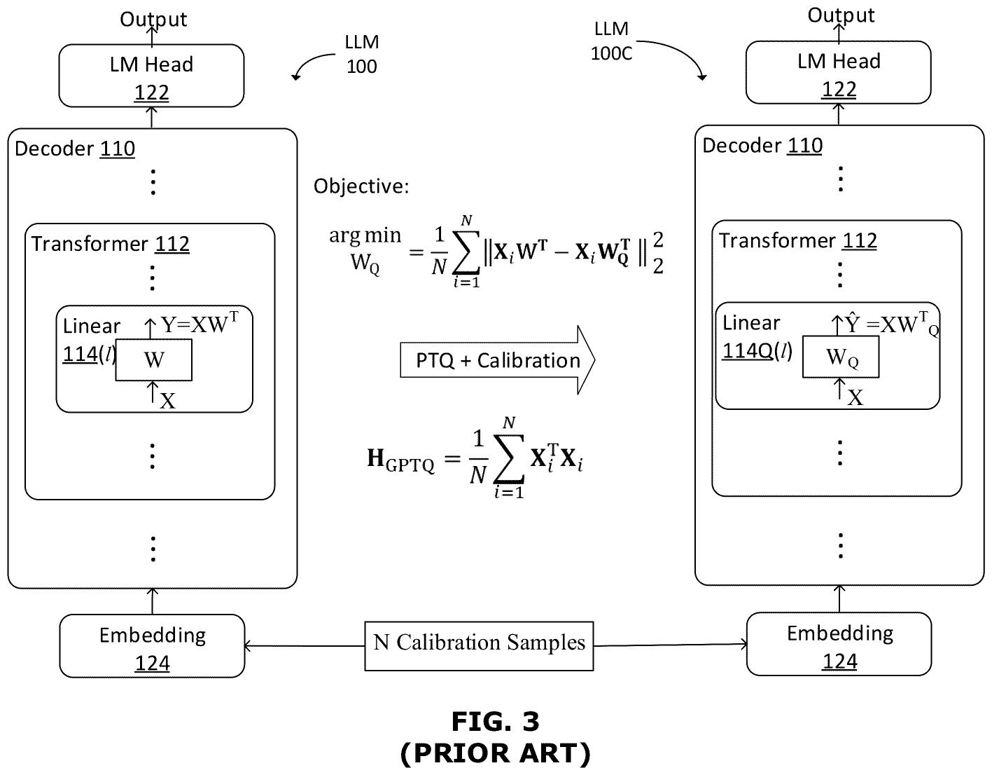

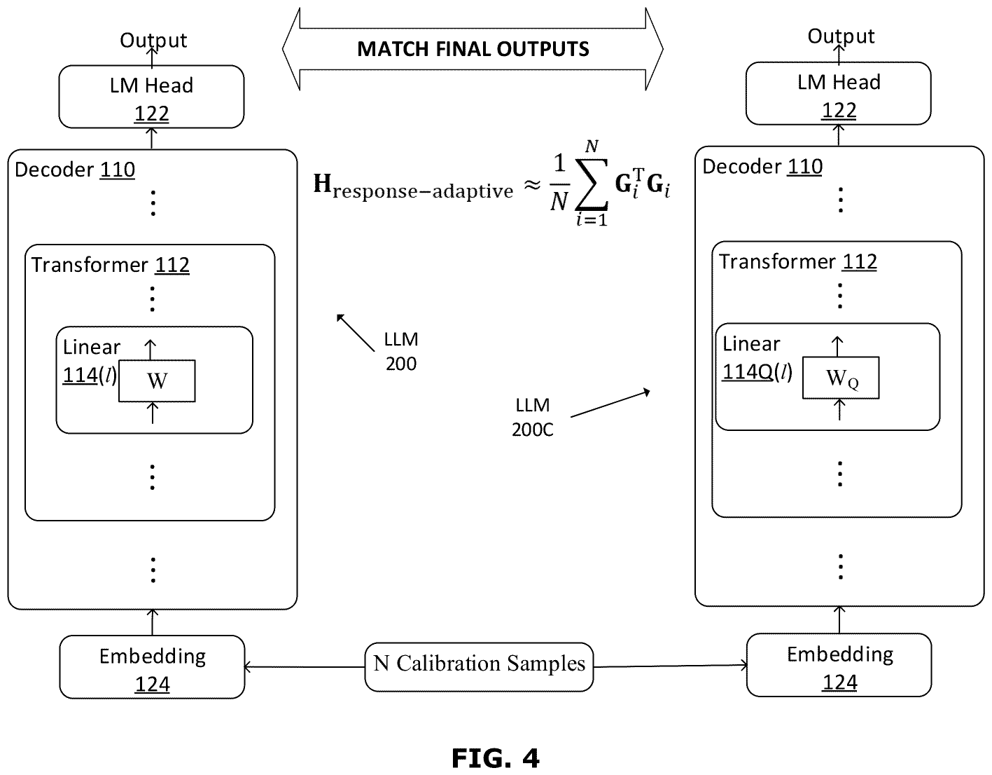

To provide a further illustration of the present solution relative to known solutions, FIG. 3 is a block diagram showing an example of a response-agnostic computation of a Hessian matrix for a model layer 114(l) when the loss function is the MSE between the output of the quantized and original layers, and FIG. 4 is a block diagram illustrating computation of a response-adaptive Hessian matrix when the objective is correcting the final output of the model, according to example implementations. FIGS. 3 and 4 illustrate aspects of the present disclosure in the context of a decoder based LLM such as the LLMs shown in FIGS. 2B and 2C above.

FIG. 3 and FIG. 4 illustrate selected elements of a post-training LLM (LLM 100 in FIG. 1; LLM 200 in FIG. 4) and a corresponding compressed LLM (LLM 100C in FIG. 1; LLM 200C in FIG. 4). The illustrated LLMs each include a respective embedding module 124, a decoder 110, and a language modelling (LM) head 122. Each decoder 110 includes a transformer block 112 that includes a neural network (NN) that comprises, among other layers, a plurality of linear neural network layers 114(1) to 114(L), where L is the number of linear layers to be quantized in transformer block 112. W denotes the set of weights (e.g., weight matrix Wϵ [symbol] ) associated with a linear layer 114(l) of post-training LLM 100,200 and W_{Q} denotes the set of quantized weights (e.g., quantized weight matrix W_{Q}ϵ [symbol] ) associated with a quantized linear layer 114Q(l) of compressed LLM 100, 200.

In the context of FIG. 3, the computed Hessian matrix H_{response-agnostic} (also denoted as H_{GPTQ}, where “GPTQ” refers to gradient post training quantization) is a positive-definite matrix that is used to correct the output of the corresponding linear layer.

The response-adaptive computation (also referred to herein as output-adaptive calibration (OAC) of the Hessian matrix H_{response-adaptive} (also denoted herein as H_{OAC})s illustrated in FIG. 4 makes the calibration process response-adaptive, with an objective of correcting the final output of the quantized model instead of the intermediate layers' outputs.

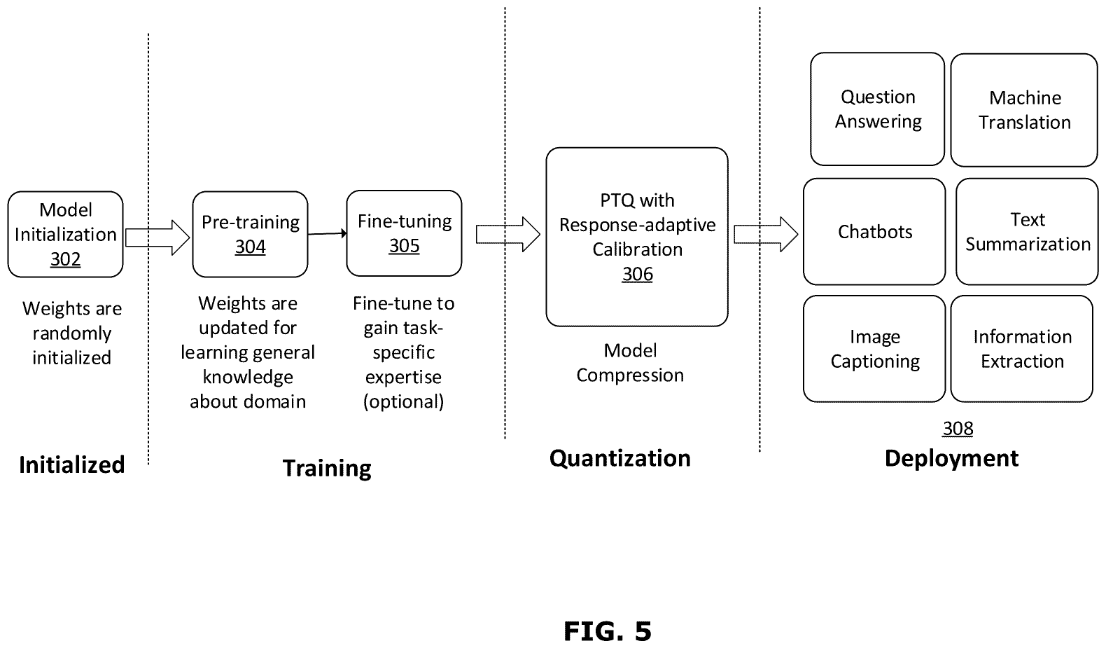

FIG. 5 shows an example of a set of operations that can be performed to obtain and deploy an LLM that has been compressed using response-adaptive quantization, according to example implementations. These operations can include: (1) Model initialization 302, during which model parameters (e.g., weights) are randomly initialized. (2) Model Training, which includes (i) pre-training 304 and (ii) optionally, fine-tuning 305. During pre-training, model weights are updated using a machine learning process and a large dataset such that the model learns general knowledge about a domain. Fine-tuning can be applied to enable a model to become an expert in a specific down-stream task. However, in some examples, the fine-tuning step can be skipped, particularly in the case of tasks for which an LLM can achieve an acceptable performance based on few-shot and zero-shot training [see REFERENCE 29, for example)]. (3) Model Quantization 306, during which the presently disclosed response-adaptive PTQ method is applied to compress the model, while maintaining its accuracy. (4) Finally, the quantized model is deployed 308 to solve the target tasks.

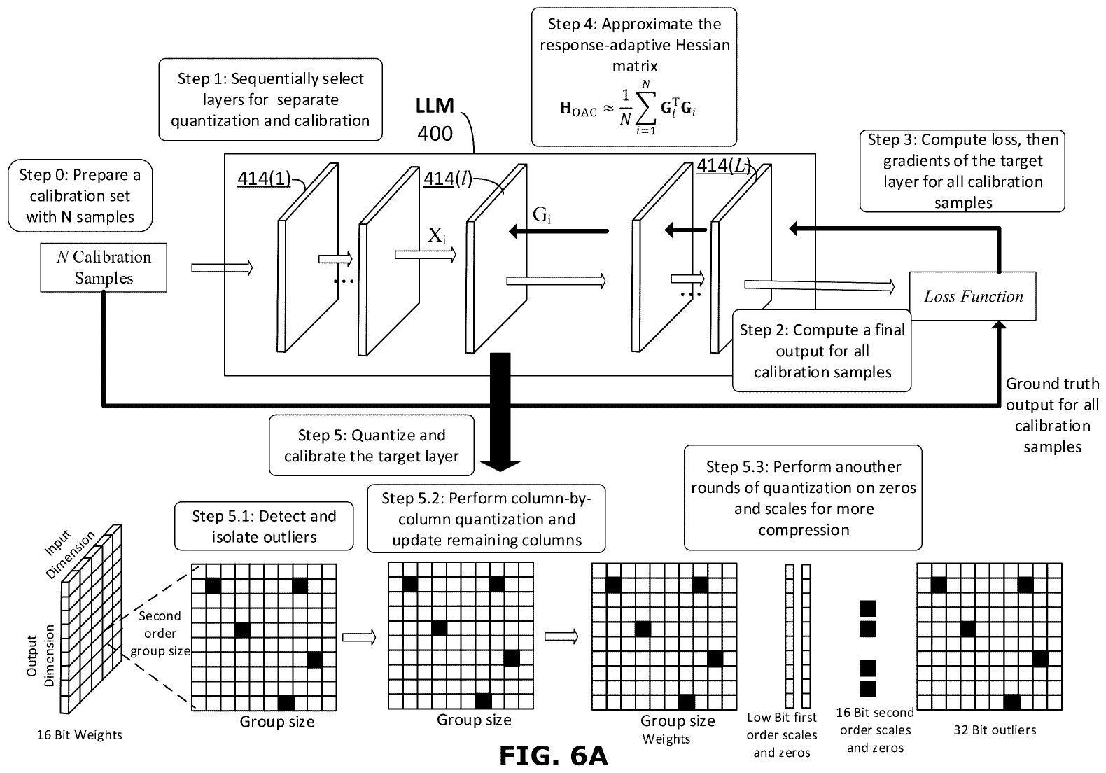

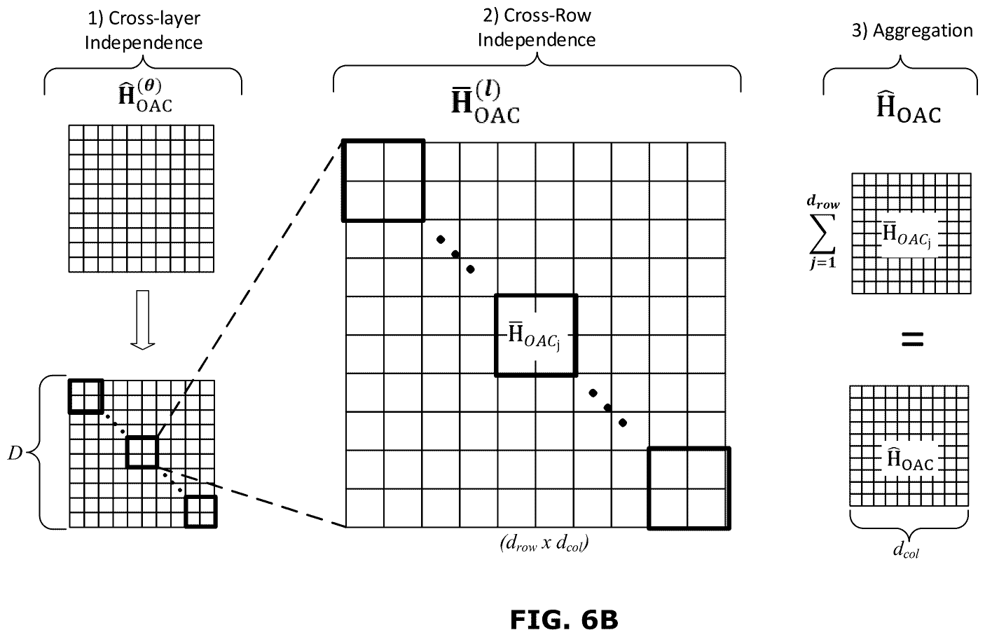

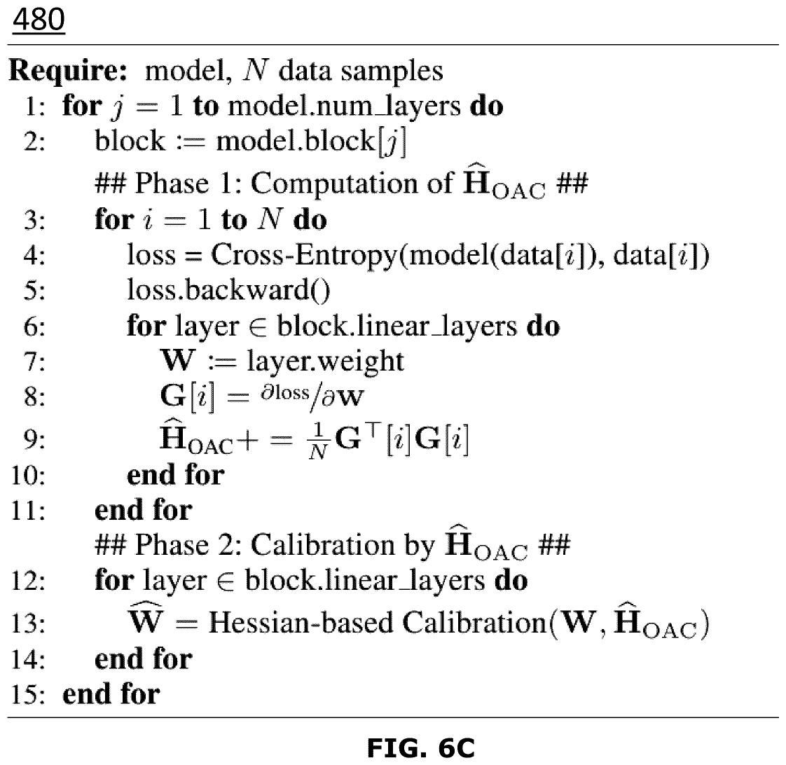

Quantization 306 using the presently disclosed response-adaptive PTQ method will now be described in greater detail with reference to FIG. 6A, which illustrates an LLM 400 (which can, for example be the same as or similar to LLM 200) that comprises, among other elements, a plurality of transformer block linear layers 414(1) to 414(L) (hereinafter reference 414(l) denotes a l^{th} linear layer that is a target layer for quantization and reference 414 collectively denotes the set of linear layers that are to be quantized).

Linear layers are the basic elements of the layers that form the transformer block layers that are the main component of LLMs. The goal of model quantization is to quantize the parameters of these linear layers while the final output of the model is minimally changed. In example implementations, the linear layers are each separately selected, quantized, and calibrated.

FIG. 4A illustrates the following steps that can be used to implement a response-adaptive PTQ method to quantize weights of the linear layers 414 according to example implementations.
Step 0: Prepare a calibration set with N samples. The calibration process is performed based on a relatively small dataset, called a calibration set. This dataset should be prepared before the beginning of the process.
Step 1: Sequentially select layers 414 for quantization and calibration. The quantization and calibration are performed iteratively over the linear layers 414 of the model.

The following steps 2 to 5 are repeated for each linear layer (e.g., each target layer 414(l)):
Step 2: Compute the final output for all calibration samples. The outputs of the model are generated given the calibration samples as inputs.
Step 3: Compute loss, then gradients of the target layer 414(j) for all calibration samples. The generated model outputs are compared with the ground truth outputs to compute the loss function, and the gradient matrix of the target linear layer 414(l) is computed for all calibration samples.
Step 4: Approximate the response-adaptive Hessian matrix H_{OAC}. The response-adaptive Hessian matrix is approximated for the target linear layer 414(l) using the gradients:

$${H}_{OAC} \approx \frac{1}{N} {\sum }_{i = 1}^{N} {G}_{i}^{T} {G}_{i}$$

Given the large size of the Hessian matrix, an approximation is used for H_{OAc}. Known methods for approximating a Hessian matrix are described in REFERENCES 2 and 6, for example.
Step 5: Quantization and calibration are performed on the target linear layer 414(l). The PTQ calibration approaches in the literature use the Hessian matrix for estimating the quantization error based on Taylor expansion, then reducing it by adding an update term to the weights. The update term is computed based on the inverse of the Hessian matrix. Therefore, by using the response-adaptive Hessian matrix H_{OAC} which is approximated based on the gradients, the calibration process becomes response-adaptive. Several alternative calibration strategies [see for example REFERENCES 4,5,7] can be used. In a one specific example, the calibration approach that is used is that disclosed in REFERENCE 7 (SpQR) with the exception that in SpQR's original method, the response-agnostic Hessian matrix is used but, in the example of FIG. 6A, the above noted response-adaptive Hessian matrix H_{OAC} is used instead. More sophisticated Hessian-based calibration approaches could be deployed as well. Quantization and calibration can, for example include the following steps:
Step 5.1: Outliers in the weight matrix W are detected according to the Hessian matrix H_{OAC}, then isolated.
Step 5.2: Skipping the outliers, the weights in weight matrix W are quantized column-by-column; when each column is getting quantized, the previous columns are fixed and the next columns are updated to reduce the quantization error [see REFERENCES 4,7]. The update term is computed based on the inverse of the Hessian matrix H_{OAC}.
Step 5.3: The extracted quantization parameters (scales and zeros) are quantized to reduce the total average bit width, compensating for the small group sizes, recommended for achieving an acceptable performance drop [REFERENCE 7].

The process of FIG. 6 can be repeated through multiple quantization iterations until an acceptable performance is achieved. Within each quantization iteration, the layers of the model are selected for quantization and calibration iteratively. For each layer, the final outputs over the calibration samples are computed. The generated outputs are compared with the ground truth outputs to compute the loss, then the gradients. The response-adaptive Hessian matrix H_{OAC}, that is used in the calibration step, is approximated based on the gradients. A response adaptive calibration technique is used for PTQ for each layer 414(l), including the following steps: isolating the outliers, column-by-column quantization while updating the remaining weights, and performing a second round of quantization on the scales and zeros.

It will thus be appreciated that FIG. 6A illustrates a process that can be applied during a quantization iteration for post-training quantization of a trained neural network (e.g., LLM 400) that includes a block of linear network layers 414(1) to 414(L). The block is configured by a non-quantized set of trained parameters θ that comprise, for each of the linear network layers 414(1) to 414(L) within the block, respective layer-specific network weights W. As a preliminary step, the trained neural network can be used to generate ground truth outputs for a set of N calibration sample inputs. Additionally, a set of quantized parameters can be initialized.

A plurality of quantization iterations (each quantization iteration comprising steps 1 to 5 of FIG. 6A) are then performed to generate a final quantized set θ_{Q} of parameters for the block corresponding to the non-quantized set θ of trained parameters. The quantized set θ_{Q} of parameters will have a reduced number of bits than the non-quantized set of trained parameters, thereby providing a quantized version of the original trained neural network that requires less memory and computational resources (e.g., fewer or lower bit calculations) for deployment than the original non-quantized model.

Each quantization iteration applies a two-step process, namely generating an approximated Hessian matrix (Steps 1 to 4 of FIG. 6A) and then applying quantization/calibration (Step 5 of FIG. 6A), during which each of the linear network layers 414(1) to 414(L) within the block is individually processed. In particular, during each quantization iteration, each of the linear network layers are successively processed as follows: (i) for each linear network layer 414(l), as per Steps 2 to 4, a respective approximated Hessian matrix is generated for the linear network layer 414(l), based on outputs generated by the block for the set of N calibration samples using a set of interim quantized parameters for the block, the set of interim quantized parameters comprising a set of layer-specific network weights for the linear network layer as computed in a preceding quantization iteration and sets of layer-specific network weights for each of the remaining linear network layers set to the values of such weights prior to the preceding quantization iteration; and (ii) an updated set of quantized set of layer-specific network weights is computed for the linear network layer 414(l) based on the respective approximated Hessian matrix for the linear network layer. In (i) above, in the case of an initial quantization iteration, the set of initialized quantized parameters can be used in place of the set of layer-specific network weights for the linear network layer as computed in a preceding quantization iteration and sets of layer-specific network weights for each of the remaining linear network layers set to the values of such weights prior to the preceding quantization iteration; and for the second iteration, the set of initialized quantized parameters can be used for the layer-specific network weights for each of the remaining linear network layers.

When a termination metric is met (e.g., a maximum number of quantization iterations is reached or a defined performance metric such as an acceptable loss is achieved) the updated quantized sets of layer-specific network weights W_{Q} computed for each of the linear network layers in a final quantization iteration are stored as the final quantized set of parameters for the block.

A further example of a possible process for approximating Hessian matrix H_{OAC} will now be described with reference to FIG. 6B. As is apparent from the above description, in contrast to existing output-agnostic approaches, output-adaptive calibration (OAC) as described herein calibrates the linear layer weights with an objective of minimizing the difference between the model output loss before and after quantization. In examples, the quantization error is measured based on the distortion of the cross-entropy loss i.e. [symbol] _{CE}(x, y, \hat{θ}) after quantizing the weights, where

$$θ = {vec [ {W}^{l} ]}_{l = 1}^{L} .$$

The quantization is denoted by \hat{θ}=θ+δθ in which δθ is the update term. Therefore, the OAC error for the final output of the subject LLM is:

$${ε}_{OAC} = {( x , y )}_{} [ {ℒ}_{CE} ( x , y , \hat{θ} ) - {ℒ}_{CE} ( x , y , θ ) ]$$

$$= δ {θ}^{T} \overline{g} + δ {θ}^{T} {\overline{H}}_{OAC}^{( θ )} δθ + 𝒪 ( {‖ δθ ‖}^{3} ) ,$$

where

$${\overline{H}}_{OAC}^{( θ )} = {( x , y )}_{} [ \frac{{\partial }^{2} {ℒ}_{CE}}{\partial θ \partial {θ}^{T}} ] ∈ {ℝ}^{DXD}$$

is the output-adaptive Hessian matrix of the entire weights of all linear layers and

$$\overline{g} = {( x , y )}_{} [ \frac{\partial {ℒ}_{CE}}{\partial θ} ] ≅ 0$$

as the model is already trained.

As indicated above, for a typical LLM, the large size of

$${\overline{H}}_{OAC}^{( θ )}$$

renders its computation prohibitive. According, in an example implementation, with reference to FIG. 6B, an approximation of

$${\overline{H}}_{OAC}^{( θ )}$$

is computed for a model based on assumptions that the liner layers are independent and that within each linear layer, each row of weight matrix W is independent of the remaining rows. of follows. Based on these assumptions, in the present example,

$${\overline{H}}_{OAC}^{( θ )}$$

is approximated by a block-diagonal matrix, where the l^{th} non-zero diagonal block, denoted by

$${\overline{H}}_{OAC}^{( l )}$$

corresponds to the output adaptive Hessian of the l^{th} linear layer, as shown in FIG. 6B.

To further simplify the notation, l is dropped from

$${\overline{H}}_{OAC}^{( l )}$$

below when there is no risk of confusion. Having assumed the cross-layer independence, the quantization error during the calibration of each linear layer is computed as:

$${ε}_{OAC} = {( x , y )}_{} [ {ℒ}_{CE} ( x , y , \hat{θ} ) - {ℒ}_{CE} ( x , y , θ ) ]$$

$$≅ δ {w}^{T} {\overline{H}}_{OAC} δ w ,$$

### Where

$$w = vec ( W ) , {\overline{H}}_{OAC} = {( x , y )}_{} [ \frac{{\partial }^{2} {ℒ}_{CE}}{\partial w \partial {w}^{T}} ] ∈$$

is the output-adaptive Hessian matrix of the target liner layer, and δw=vec (Ŵ−W) is the update term.

As the rows of weight matrix W are assumed to be independent and the columns of W are iteratively calibrated, an optimal update can be computed by solving:

$${arg min}_{δ W} δ {W}^{⊤} {\overline{H}}_{OAC} δ W ≅ {\sum }_{j = 1}^{{d}_{row}} δ {W}_{j , :} {\overline{H}}_{OACj} δ {W}_{j , :}^{⊤}$$

$$s . t . δ {W}_{: , q} = {\hat{W}}_{: , q} - {W}_{: , q}$$

where only the row-wise Hessians, H̅_{OACj}, are needed, such that the memory footprint is reduced. In example implementations, the memory footprint can be further reduced by aggregating row-wise Hessians, such that H̅_{OACj} is replaced with

$${\sum }_{j = 1}^{{d}_{row}} {\overline{H}}_{OACj} ,$$

thus transforming the quantization error computation to:

$${arg min}_{δ W} {ε}_{OAC} ≅ tr ( δ W {\hat{H}}_{OAC} δ {W}^{⊤} )$$

$$s . t . δ {W}_{: , q} = {\hat{W}}_{: , q} - {W}_{: , q *}$$

Note that tr(δWĤ_{OAC}δW^{T}) is an upper bound for

$${\sum }_{j = 1}^{{d}_{row}} δ {W}_{j , :} {\overline{H}}_{OACj} δ {W}_{j , :}^{⊤}$$

since all H̅_{OACj} matrices are positive definite.

Building on the above, in the presently described example implementation, Ĥ_{OAC} for the linear layers 414 of the LLM 400 can be computed as follows. Let Wϵ [symbol] be the weight matrix of the l^{th} linear layer in an LLM resulted by concatenating d_{row} rows. Following the cross-layer independence assumption, the Hessian of W is independent of other layers. Also, based on the cross-row independence assumption, the Hessian for each row of W is independent of other rows. The output adaptive Hessian of the j^{th} row of the gradient matrix, where G_{j,:[i]} is the j^{th} row of the gradient matrix, Gᵢϵ [symbol] , computed for the i^{th} calibration sample, is:

$${\overline{H}}_{{OAC}_{j}} ≅ \frac{1}{N} {\sum }_{i = 1}^{N} {G}_{j , :}^{T} [ i ] {G}_{j , :} [ i ] .$$

Then, all of the row-wise Hessians are aggregated to compute

$${\hat{H}}_{OAC} ≅ {\sum }_{j = 1}^{drow} {\overline{H}}_{{OAC}_{j}} ≅ \frac{1}{N} {\sum }_{i = 1}^{N} {\sum }_{j = 1}^{drow} {{G}_{j , :} [ i ]}^{⊤} {G}_{j , :} [ i ]$$

$$= \frac{1}{N} {\sum }_{i = 1}^{N} {G [ i ]}^{T} G [ i ] .$$

FIG. 6C shows a pseudocode representation 480 of an iteration of an output-adaptive calibration process that can apply the Hessian approximation represented in FIG. 6B, to quantize a block of linear NN layers. As with the process represented in FIG. 4A, the process represented in FIG. 6C comprises two main phases for post training quantization of weights, namely: (i) Computing the output-adaptive Hessian of each weight matrix corresponding to a respective linear layer; and (ii) Calibrating each weight matrix using its output-adaptive Hessian.

In the first phase, the above-described equation:

$${\hat{H}}_{OAC} ≅ \frac{1}{N} {\sum }_{i = 1}^{N} {G [ i ]}^{T} G [ i ]$$

is used to approximate the Hessian matrix of each weight matrix. This requires computing the gradients of each weight matrix for all calibration samples. In example implementations where a LLM includes multiple transformer blocks that each include multiple liner layers, the gradients of the linear layers inside each transformer block can be computed simultaneously, while other transformer blocks of the LLM are frozen. This avoids repeating the costly output generation and backpropagation for all linear layers within a transformer block. As shown in FIG. 6C, the transformer blocks are iteratively selected. For each block, the model outputs are generated using the calibration samples. Following the calculation of the cross-entropy loss, backpropagation is used to compute the gradients of the weights associated with the linear layers within the subject block. Then, the Hessian matrix H_{OAC} of each of the linear layers within the block are separately approximated.

In the second phase the Hessian matrix H_{OAC} of each of the linear layers obtained during the first phase are used for calibration as follows. Any number of suitable Hessian-based calibration methods can be applied to achieve this second phase. However, in at least some example implementations where accurate 2-bit PTQ of an LLM is desired, steps from SpQR (REFERENCE 7) are integrated into the second phase as follows, in which the Hessian H_{OAC} approximated as described herein is used in place of the Hessian matrix approximation disclosed in SpQR. In this regard, the salient weights s_{j,k} are detected and isolated using the equation:

$${s}_{j , k} = \frac{{( {W}_{j , k} - {\hat{W}}_{j , k} )}^{2}}{{[ {\hat{H}}_{OAC}^{- 1} ]}_{k , k}}$$

where j,k denote the (j,k)^{th} element of a matix. Then, the column-wise updating process is performed to reduce the distortion of the cross-entropy loss. Likewise, the update term disclosed in SpQR is computed by replacing Hessian matrix approximation as disclosed in SpQR with the Hessian Ĥ_{OAC} approximated as described herein. Finally, the scales and zeros are quantized to reduce the average bit hence enabling smaller group quantization and keeping more outliers in single-precision floating-point format (e.g., the FP32 format).

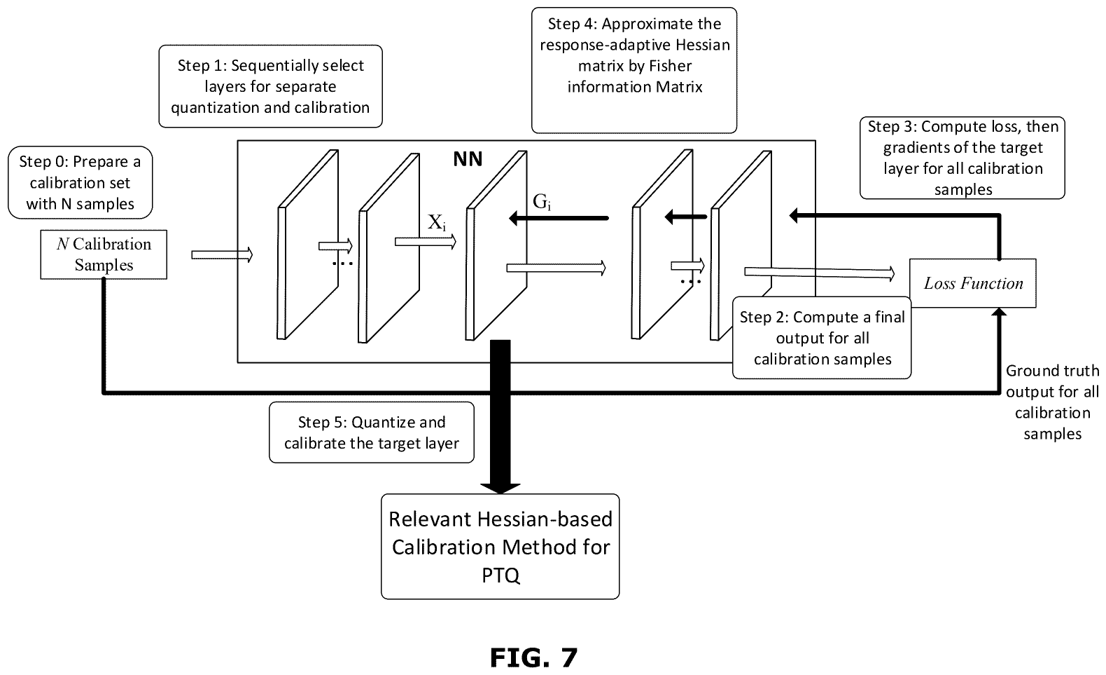

A further example implementation is illustrated in FIG. 7. In the example of FIG. 7, a generalized version of the example of FIG. 6A is shown. In general, LLMs are a particular type of transformer-based NNs. Aside from LLMs, the PTQ techniques and methods disclosed herein are applicable to all NNs including vision transformers [REFERENCE 14], Convolutional Neural Networks (CNNs) [REFERENCE 15], and Recurrent Neural Networks (RNNs) [REFERENCE 16]. The overall steps and algorithm are similar to that described above in respect of FIG. 6A. However, another calibration method that better matches the architecture of the target neural network might be used instead of that described above. FIG. 5 shows how a generic solution can be applied for PTQ of all neural networks by using a relevant Hessian-based calibration method for PTQ.

In FIG. 7, PTQ in the case of general NNs is done as follows: The layers of the model are selected for quantization and calibration iteratively. For each layer, the final outputs over the calibration samples are computed. The generated outputs are compared with the ground truth outputs to compute the loss, then the gradients. The response-adaptive Hessian, that is used in the calibration step, is approximated based on the gradients. Finally, a suitable calibration method relevant to the architecture of the model is utilized for PTQ.

In a further example implementation, a response adaptive Hessian matrix is applied for calibration of unstructured pruned NNs. Unstructured pruning can be considered as a form of quantization that replaces the unnecessary weights with zeros [REFERENCE 17]. Similar to PTQ, there are calibration methods in the literature to update the remaining weights to compensate for the pruned weights like SparseGPT [REFERENCE 18]. In the present example implementation, the step disclosed above in respect of FIG. 6A are modified for application in the context of calibration of unstructured pruned NNs. In particular, the step of calibration plus PTQ (step 5) is replaced with a proper calibration plus unstructured pruning method that can for example be based on SparseGPT [REFERENCE 18].

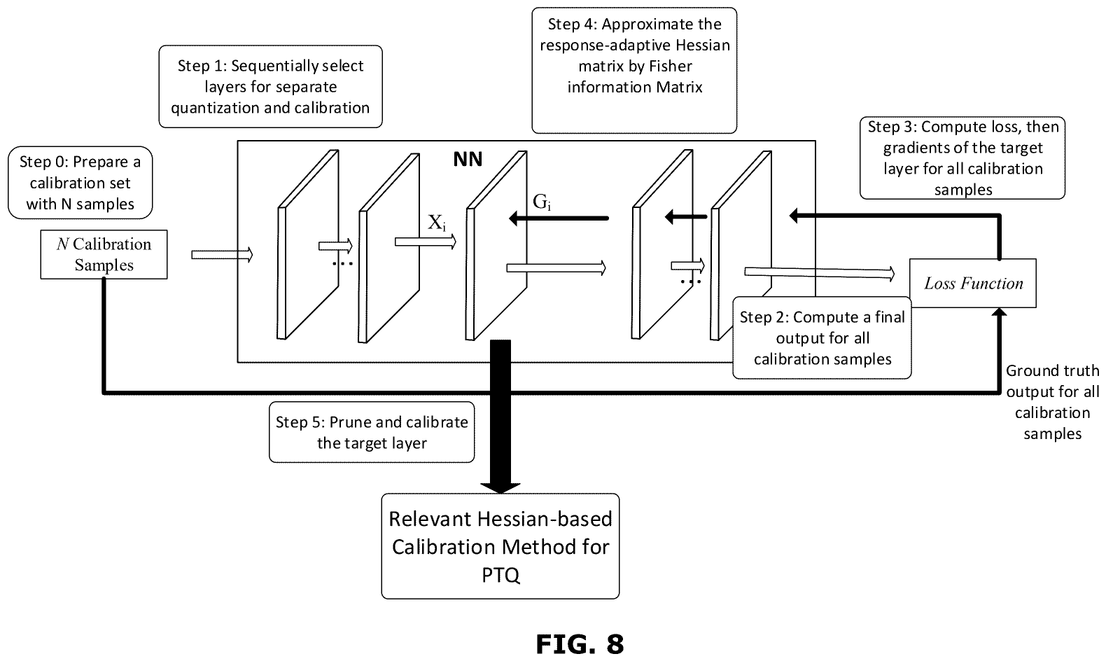

In this regard, Step 5 can be performed as follows: Unstructured pruning and calibration are performed on the linear layer. The Hessian-based LLM pruning [REFERENCE 18]methods in the literature use the Hessian matrix for estimating the pruning error based on Taylor expansion, then reducing it by adding an update term to the remaining weights. The update term is computed based on the inverse of the Hessian matrix. Therefore, by using the response-adaptive Hessian matrix which is approximated based on the gradients, the calibration process becomes response-adaptive. FIG. 8 shows application of the disclosed methods for unstructured pruning of neural networks. In the example of FIG. 8, the layers of the model are selected for pruning and calibration iteratively. For each layer, the final outputs over the calibration samples are computed. The generated outputs are compared with the ground truth outputs to compute the loss, then the gradients. The response-adaptive Hessian matrix used in the calibration step is approximated based on the gradients. Finally, a proper calibration method relevant to the architecture of the model is utilized for unstructured pruning. For example, SparseGPT [REFERENCE 18] could be used for pruning of LLMs.

In a further example implementation, gradient approximation is used for computation of the Response Adaptive Hessian to calibrate unstructured pruned or post-training quantized NNs.

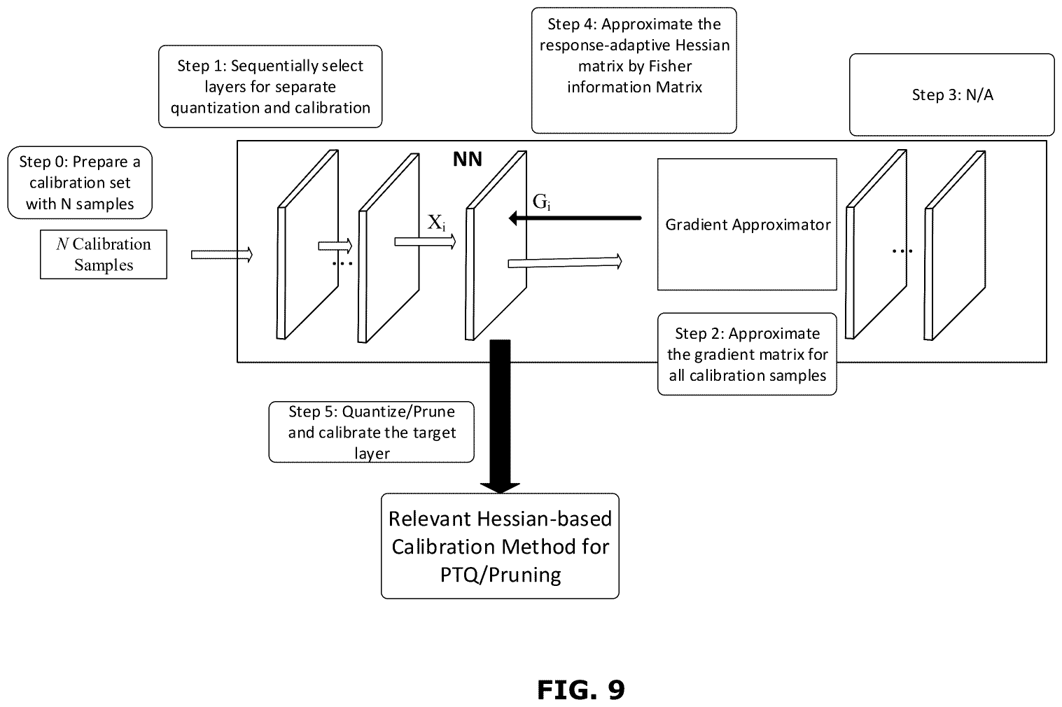

In the previous examples, computing of the gradient matrix is required for each layer over all calibration samples. However, there are some approaches that approximate the gradient matrix for each layer without performing the backpropagation [REFERENCES 19,20]. These approaches can be used in our pipeline to alleviate the need for backpropagation to reduce the computational costs. Therefore, only steps 2 and 3 will be different from the previous embodiments. FIG. 9 shows the workflow of this embodiment, with the following modifications when compared to FIG. 7:
Step 2: Instead of computing the forward path and performing the backpropagation to find the gradient matrix for each layer, the desired gradient approximation method is performed to approximate the gradient matrix based on the input.
Step 3: This step is skipped, leading to reduced computational costs.

Thus, FIG. 9 shows an embodiment that uses a gradient approximator module for PTQ/pruning of general NNs. The layers of the model are selected for PTQ/pruning iteratively. The gradient approximator module approximates the gradients for each layer. Then, the response-adaptive Hessian matrix that is used in the calibration step is approximated based on the approximated gradients. Finally, a proper calibration method relevant to the architecture of the model is utilized for PTQ/pruning. Gradient approximation is the key difference between this embodiment of FIG. 9 and the previous embodiments. Therefore, this embodiment can be used for both PTQ and unstructured pruning of all NNs.

In the example embodiments, response-adaptive Hessian matrix, approximated using gradients, is used for calibration of quantized models. In some scenarios, this can enable more accurate PTQ of LLMs and in some examples can enable extremely low-bit (2-bit) quantization of LLMs that maintain a suitable accuracy level.

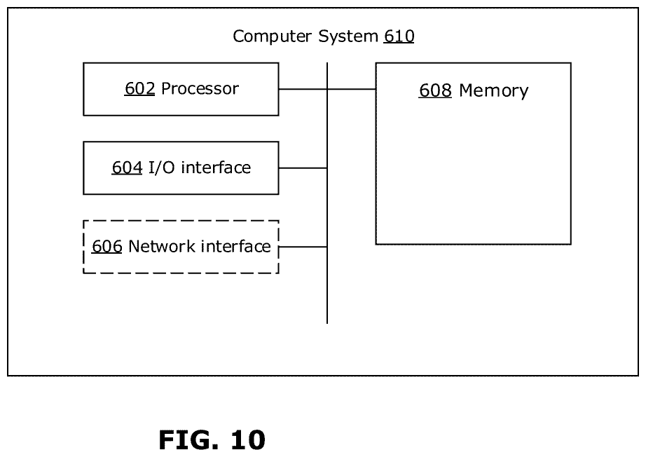

FIG. 10 illustrates an example of a computer system 610 that can be used to implement the one or more systems of the present disclosure, including for example a system that implements the operations of FIG. 3. Computer system 610 includes one or more processors 602, such as a central processing unit, a general processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 602 may collectively be referred to as a “processor device”. The computer system 610 also includes one or more input/output (I/O) interfaces 604, which interfaces with input devices (e.g., microphone) and output devices (e.g., speaker).

The computer system 610 can include one or more network interfaces 606 that may, for example, enable the computer system 610 to communicate with one or more further devices through a communications network such as a local area wireless network.

The computer system 610 includes one or more memories 608, which may include a volatile or non-volatile memory (e.g., a flash memory, a random access memory (RAM), and/or a read-only memory (ROM)). The non-transitory memory(ies) 608 may store instructions for execution by the processor(s) 602, such as to carry out examples described in the present disclosure.

The memory(ies) 608 may include other software instructions, such as for implementing an operating system and other applications/functions. In the illustrated example, the memory 608 includes specialized software instructions 1161 for implementing one or more of the solutions described herein.

In some examples, the computer system 610 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computer system 610) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computer system 610 may communicate with each other via a bus, for example.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The terms “substantially” and “approximately” as used in this disclosure can mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. By way of illustration, in some examples, the terms “substantially” and “approximately”, can mean a range of within 5% of the stated characteristic.

As used herein, statements that a second item is “based on” a first item can mean that properties of the second item are affected or determined at least in part by properties of the first item. The first item can be considered an input to an operation or calculation, or a series of operations or calculations that produces the second item as an output that is not independent from the first item.

The contents of all published documents identified in this disclosure are incorporated herein by reference.

### REFERENCES

[1] Liu, Zhenhua, Yunhe Wang, Kai Han, Wei Zhang, Siwei Ma, and Wen Gao. “Post-training quantization for vision transformer.” Advances in Neural Information Processing Systems 34 (2021): 28092-28103.
[2] Li, Yuhang, Ruihao Gong, Xu Tan, Yang Yang, Peng Hu, Qi Zhang, Fengwei Yu, Wei Wang, and Shi Gu. “Brecq: Pushing the limit of post-training quantization by block reconstruction.” arXiv preprint arXiv:2102.05426 (2021).
[3] Nagel, Markus, Rana Ali Amjad, Mart Van Baalen, Christos Louizos, and Tijmen Blankevoort. “Up or down?adaptive rounding for post-training quantization.” In International Conference on Machine Learning, pp. 7197-7206. PMLR, 2020.
[4] Frantar, Elias, Saleh Ashkboos, Torsten Hoefler, and Dan Alistarh. “OPTQ: Accurate quantization for generative pre-trained transformers.” In The Eleventh International Conference on Learning Representations. 2022.
[5] Chee, Jerry, Yaohui Cai, Volodymyr Kuleshov, and Christopher M. De Sa. “Quip: 2-bit quantization of large language models with guarantees.” Advances in Neural Information Processing Systems 36 (2024).
[6] Kim, Sehoon, Coleman Hooper, Amir Gholami, Zhen Dong, Xiuyu Li, Sheng Shen, Michael W. Mahoney, and Kurt Keutzer. “Squeezellm: Dense-and-sparse quantization.” arXiv preprint arXiv:2306.07629 (2023).
[7] Dettmers, Tim, Ruslan Svirschevski, Vage Egiazarian, Denis Kuznedelev, Elias Frantar, Saleh Ashkboos, Alexander Borzunov, Torsten Hoefler, and Dan Alistarh. “Spqr: A sparse-quantized representation for near-lossless llm weight compression.” arXiv preprint arXiv:2306.03078 (2023).
[8] Hassibi, Babak, and David Stork. “Second order derivatives for network pruning: Optimal brain surgeon.” Advances in neural information processing systems 5 (1992).
[9] Touvron, Hugo, Louis Martin, Kevin Stone, Peter Albert, Amjad Almahairi, Yasmine Babaei, Nikolay Bashlykov et al. “Llama 2: Open foundation and fine-tuned chat models.” arXiv preprint arXiv:2307.09288 (2023).
[10] Achiam, Josh, Steven Adler, Sandhini Agarwal, Lama Ahmad, Ilge Akkaya, Florencia Leoni Aleman, Diogo Almeida et al. “Gpt-4 technical report.” arXiv preprint arXiv:2303.08774 (2023).
[11]--, “Introducing chatgpt,” OpenAI Blog, November 2022.
[12] Almazrouei, Ebtesam, Hamza Alobeidli, Abdulaziz Alshamsi, Alessandro Cappelli, Ruxandra Cojocaru, Merouane Debbah, Etienne Goffinet et al. “The falcon series of open language models.” arXiv preprint arXiv:2311.16867 (2023).
[13] Jiang, Albert Q., Alexandre Sablayrolles, Arthur Mensch, Chris Bamford, Devendra Singh Chaplot, Diego de las Casas, Florian Bressand et al. “Mistral 7B.” arXiv preprint arXiv:2310.06825 (2023).
[14] Dosovitskiy, Alexey, Lucas Beyer, Alexander Kolesnikov, Dirk Weissenborn, Xiaohua Zhai, Thomas Unterthiner, Mostafa Dehghani et al. “An image is worth 16×16 words: Transformers for image recognition at scale.” arXiv preprint arXiv:2010.11929 (2020).
[15] He, Kaiming, Xiangyu Zhang, Shaoqing Ren, and Jian Sun. “Deep residual learning for image recognition.” In Proceedings of the IEEE conference on computer vision and pattern recognition, pp. 770-778. 2016.
[16] Sherstinsky, Alex. “Fundamentals of recurrent neural network (RNN) and long short-term memory (LSTM) network.” Physica D: Nonlinear Phenomena 404 (2020): 132306.
[17] Frantar, Elias, and Dan Alistarh. “Optimal brain compression: A framework for accurate post-training quantization and pruning.” Advances in Neural Information Processing Systems 35 (2022): 4475-4488.
[18] Frantar, Elias, and Dan Alistarh. “Sparsegpt: Massive language models can be accurately pruned in one-shot.” In International Conference on Machine Learning, pp. 10323-10337. PMLR, 2023.
[19] Nesterov, Yurii, and Vladimir Spokoiny. “Random gradient-free minimization of convex functions.” Foundations of Computational Mathematics 17, no. 2 (2017): 527-566.
[20] Shamir, Ohad. “An optimal algorithm for bandit and zero-order convex optimization with two-point feedback.” Journal of Machine Learning Research 18, no. 52 (2017): 1-11.
[21] Radford, Alec, Jong Wook Kim, Tao Xu, Greg Brockman, Christine McLeavey, and Ilya Sutskever. “Robust speech recognition via large-scale weak supervision.” In International Conference on Machine Learning, pp. 28492-28518. PMLR, 2023.
[22] Tim Brooks, Bill Peebles, Connor Holmes, Will DePue, Yufei Guo, Li Jing, David Schnurr, Joe Taylor, Troy Luhman, Eric Luhman, Clarence Ng, Ricky Wang, and Aditya Ramesh. 2024. Video generation models as world simulators.
[23] Vaswani, Ashish, Noam Shazeer, Niki Parmar, Jakob Uszkoreit, Llion Jones, Aidan N. Gomez, Lukasz Kaiser, and Illia Polosukhin. “Attention is all you need.” Advances in neural information processing systems 30 (2017).
[24] Gholami, Amir, Sehoon Kim, Zhen Dong, Zhewei Yao, Michael W. Mahoney, and Kurt Keutzer. “A survey of quantization methods for efficient neural network inference.” In Low-Power Computer Vision, pp. 291-326. Chapman and Hall/CRC, 2022.
[25] He, Yang, and Lingao Xiao. “Structured pruning for deep convolutional neural networks: A survey.” IEEE Transactions on Pattern Analysis and Machine Intelligence (2023).
[26] Raffel, Colin, Noam Shazeer, Adam Roberts, Katherine Lee, Sharan Narang, Michael Matena, Yanqi Zhou, Wei Li, and Peter J. Liu. “Exploring the limits of transfer learning with a unified text-to-text transformer.” Journal of machine learning research 21, no. 140 (2020): 1-67.
[27] Merity, Stephen, Caiming Xiong, James Bradbury, and Richard Socher. “Pointer sentinel mixture models.” arXiv preprint arXiv:1609.07843 (2016).
[28] Marcus, Mitch, Beatrice Santorini, and Mary Ann Marcinkiewicz. “Building a large annotated corpus of English: The Penn Treebank.” Computational linguistics 19, no. 2 (1993): 313-330.
[29] Brown, Tom, Benjamin Mann, Nick Ryder, Melanie Subbiah, Jared D. Kaplan, Prafulla Dhariwal, Arvind Neelakantan et al. “Language models are few-shot learners.” Advances in neural information processing systems 33 (2020): 1877-1901.
[30] Li, Xinlin, Bang Liu, Yaoliang Yu, Wulong Liu, Chunjing Xu, and Vahid Partovi Nia. “S $\hat{ } 3$: Sign-Sparse-Shift Reparametrization for Effective Training of Low-bit Shift Networks.” Advances in Neural Information Processing Systems 34 (2021): 14555-14566.

1. A computer implemented method for post-training quantization of a trained neural network, the trained neural network comprising a block of linear network layers, the block being configured by a non-quantized set of trained parameters that comprise, for each of the linear network layers within the block, respective layer-specific network weights, the method comprising:
performing a plurality of quantization iterations to generate a final quantized set of parameters for the block corresponding to the non-quantized set of trained parameters, the quantized set of parameters having a reduced number of bits than the non-quantized set of trained parameters, each quantization iteration comprising:
successively processing each of the linear network layers, the processing for each liner network layer comprising:
computing a respective approximated Hessian matrix for the linear network layer based on outputs generated by the block for a set of calibration samples using a set of interim quantized parameters for the block, the set of interim quantized parameters comprising a set of layer-specific network weights for the linear network layer as computed in a preceding quantization iteration and sets of layer-specific network weights for each of the remaining linear network layers set to the values of such weights prior to the preceding quantization iteration, and
computing an updated set of quantized set of layer-specific network weights for the linear network layer based on the respective approximated Hessian matrix for the linear network layer;
and
storing, as the final quantized set of parameters for the block, the updated quantized sets of layer-specific network weights computed for each of the linear network layers in a final quantization iteration of the plurality of quantization iterations.

2. The method of claim 1 wherein computing the respective approximated Hessian matrix for the linear network layer comprises:
computing final outputs of the trained neural network for all of the calibration samples in the set of calibration samples;
computing a loss for all the calibration samples based on a comparison of the final outputs to ground truth values of the calibration samples determined for the neural network using the non-quantized set of trained parameters;
computing, based on the computed loss, a gradient matrix for the updated set of layer-specific network weights for the linear network layer; and
computing the respective approximated Hessian matrix for the linear network layer based on the gradient matrix.

3. The method of claim 2 wherein the computed loss is a cross-entropy loss, and computing the gradient matrix comprises applying backpropagation to compute the gradient matrix.

4. The method of claim 1 wherein computing the respective approximated Hessian matrix for the linear network layer comprising computing a Fisher information matrix.

5. The method of claim 1 wherein computing the updated set of quantized set of layer-specific network weights for the linear network layer comprises:
detecting, based on the approximated Hessian matrix for the linear network layer, outlier weights in the set of layer-specific network weights for the linear network layer as computed in the preceding quantization iteration;
quantizing any non-outlier weights in the set of layer-specific network weights while maintaining any outlier weights at their respective non-quantized values;
outputting a matrix comprising the quantized non-outlier weights and the non-quantized outlier weights as the updated set of quantized set of layer-specific network weights.

6. The method of claim 5 wherein the non-outlier weights are quantized on column-by-column basis.

7. The method of claim 1 wherein computing the updated set of quantized set of layer-specific comprises applying unstructured pruning to the set of layer-specific network weights based on the approximated Hessian matrix for the linear network layer.

8. The method of claim 1 wherein computing the respective approximated Hessian matrix for the linear network layer comprises computing an approximated gradient matrix for the linear network layer based on input values included in the calibration samples.

9. The method of claim 1 wherein the trained neural network comprises a large language model, and the block of linear network layers are part of a transformer block of a decoder network of the large language model.

10. The method of claim 1 comprising deploying a low-bit deep neural network version of the trained neural network, the low-bit deep neural network comprising a block of linear network layers being configured by the final quantized set of parameters.

11. The method of claim 10 comprising performing a task using the low-bit deep neural network version, the task being selected from a group consisting of:
machine translation; image captioning; information extraction; text summarization; question answering; and chatbot dialog generation.

12. A computer system comprising:
one or more processors; and
one or more memories coupled to the processor, the one or more memories storing instructions that, when executed, configure the one or more processors to perform post-training quantization of a trained neural network, the trained neural network comprising a block of linear network layers, the block being configured by a non-quantized set of trained parameters that comprise, for each of the linear network layers within the block, respective layer-specific network weights, the performing comprising:
performing a plurality of quantization iterations to generate a final quantized set of parameters for the block corresponding to the non-quantized set of trained parameters, the quantized set of parameters having a reduced number of bits than the non-quantized set of trained parameters, each quantization iteration comprising:
successively processing each of the linear network layers, the processing for each liner network layer comprising:
computing a respective approximated Hessian matrix for the linear network layer based on outputs generated by the block for a set of calibration samples using a set of interim quantized parameters for the block, the set of interim quantized parameters comprising a set of layer-specific network weights for the linear network layer as computed in a preceding quantization iteration and sets of layer-specific network weights for each of the remaining linear network layers set to the values of such weights prior to the preceding quantization iteration, and
computing an updated set of quantized set of layer-specific network weights for the linear network layer based on the respective approximated Hessian matrix for the linear network layer;
and
storing, as the final quantized set of parameters for the block, the updated quantized sets of layer-specific network weights computed for each of the linear network layers in a final quantization iteration of the plurality of quantization iterations.

13. The computer system of claim 12 wherein computing the respective approximated Hessian matrix for the linear network layer comprises:
computing final outputs of the trained neural network for all of the calibration samples in the set of calibration samples;
computing a loss for all the calibration samples based on a comparison of the final outputs to ground truth values of the calibration samples determined for the neural network using the non-quantized set of trained parameters;
computing, based on the computed loss, a gradient matrix for the updated set of layer-specific network weights for the linear network layer; and
computing the respective approximated Hessian matrix for the linear network layer based on the gradient matrix.

14. The computer system of claim 13 wherein the computed loss is a cross-entropy loss, and computing the gradient matrix comprises applying backpropagation to compute the gradient matrix.

15. The computer system of claim 12 wherein computing the respective approximated Hessian matrix for the linear network layer comprising computing a Fisher information matrix.

16. The computer system of claim 12 wherein computing the updated set of quantized set of layer-specific network weights for the linear network layer comprises:
detecting, based on the approximated Hessian matrix for the linear network layer, outlier weights in the set of layer-specific network weights for the linear network layer as computed in the preceding quantization iteration;
quantizing any non-outlier weights in the set of layer-specific network weights while maintaining any outlier weights at their respective non-quantized values;
outputting a matrix comprising the quantized non-outlier weights and the non-quantized outlier weights as the updated set of quantized set of layer-specific network weights.

17. The computer system of claim 12 wherein computing the updated set of quantized set of layer-specific comprises applying unstructured pruning to the set of layer-specific network weights based on the approximated Hessian matrix for the linear network layer.

18. The computer system of claim 12 wherein computing the respective approximated Hessian matrix for the linear network layer comprises computing an approximated gradient matrix for the linear network layer based on input values included in the calibration samples.

19. The computer system of claim 12 wherein the trained neural network comprises a large language model, and the block of linear network layers are part of a transformer block of a decoder network of the large language model.

20. A non-transitory processor readable media storing instructions that, when executed, configure one or more processors to perform a method for post-training quantization of a trained neural network, the trained neural network comprising a block of linear network layers, the block being configured by a non-quantized set of trained parameters that comprise, for each of the linear network layers within the block, respective layer-specific network weights, the method comprising:
performing a plurality of quantization iterations to generate a final quantized set of parameters for the block corresponding to the non-quantized set of trained parameters, the quantized set of parameters having a reduced number of bits than the non-quantized set of trained parameters, each quantization iteration comprising:
successively processing each of the linear network layers, the processing for each liner network layer comprising:
computing a respective approximated Hessian matrix for the linear network layer based on outputs generated by the block for a set of calibration samples using a set of interim quantized parameters for the block, the set of interim quantized parameters comprising a set of layer-specific network weights for the linear network layer as computed in a preceding quantization iteration and sets of layer-specific network weights for each of the remaining linear network layers set to the values of such weights prior to the preceding quantization iteration, and
computing an updated set of quantized set of layer-specific network weights for the linear network layer based on the respective approximated Hessian matrix for the linear network layer;
and
storing, as the final quantized set of parameters for the block, the updated quantized sets of layer-specific network weights computed for each of the linear network layers in a final quantization iteration of the plurality of quantization iterations.
